(19) United States
(12) Patent Application Publication
(10) Pub. No.: US 2026/0354384 A1
(43) Pub. Date: Nov. 12, 2026

(54) METHOD OF CONTROLLING PHYTOPATHOGENIC FUNGI

(71) Applicants: UPL MAURITIUS LIMITED, Port Louis (MU); UPL EUROPE SUPPLY CHAIN GMBH, Risch-Rotkreuz (CH)

(72) Inventors: Ayrton Berger Neto, Campinas - SP (BR); Estelle Moreau, Saint Malo (FR)

(21) Appl. No.: 19/129,836

(22) PCT Filed: Nov. 15, 2023
(86) PCT No.: PCT/EP2023/081880

§ 371 Date: May 14, 2025

(30) Foreign Application Priority Data
Nov. 17, 2022 (EP) 22306691.1

(51) Int. Cl. A01N 59/20; A01N 59/02; A01P 3/00

(52) U.S. Cl. CPC A01N 59/20; A01N 59/02; A01P 3/00

(57) ABSTRACT

The present disclosure relates to a method of controlling fungal diseases in soybean crop. The present disclosure further relates to a fungicidal combination for controlling fungal diseases in soybean crop. The present disclosure also relates to corresponding compositions and use thereof.

### TECHNICAL FIELD

The present invention relates to a method of controlling fungal diseases in soybean crop. The present invention further relates to a fungicidal combination for controlling fungal diseases in soybean crop.

### BACKGROUND AND PRIOR ART

Soybean [Glycine max (L.) Merr.] is a major commercial oilseed crop produced and consumed worldwide. Soybean is arguably the most versatile row crop on earth. It has been cultivated in temperate ecologies for several thousand years. Initially it was cultivated in northern Asia and in more recent decades in North America and in countries of Latin America. The crop is cultivated on an estimated 6% of the world's arable land, and since the 1970s, the area under soybean cultivation marked the greatest percentage increase compared to any other major crop. Currently, the share of soybean in global oilseed production is around 55%, and over the last 10 years its production has expanded at a rate of over 5% per year on an average.

The potential always exists for a bacterial, fungal, or viral disease to develop in soybean crop. Potential yield loss related to a disease infection can be minimal or excessively damaging depending on the disease, the environment, time of infection, and the soybean product. Soybean foliage is susceptible to numerous fungal and bacterial pathogens. These pathogens cause leaf spots and blights.

The fungal diseases of importance causing significant economic loss in soyabean cultivations include Asian Soyabean Rust (ASR) by Phakopsora pachyrhizi, powdery mildew by Erysiphe diffusa, Frogeye leaf spot (FLS) caused by the fungus, Cercospora sojina, brown spot caused by Septoria glycines, amongst several other diseases.

Powdery mildew caused by fungus Erysiphe diffusa (syn. Microsphaera diffusa) is an important disease in soybean cultivations, observed particularly in the United States, Paraguay, Brazil and Bolivia. The most efficient and economical method to control powdery mildew is the use of resistant soybean cultivars. Yield losses resulting from powdery mildew infection as high as 50%-60% have been reported in many countries. However, due to the large pathogenic variability of Erysiphe diffusa, some cultivars may have their resistance overcome by the pathogen. Moreover, resistant soybean cultivars are still not available.

Soybean rust is a destructive foliar disease of soybean caused by Phakopsora pachyrhizi. Asian soybean rust is an aggressive disease that destroys photosynthetic tissue, causing premature defoliation, early maturation, and lower yields.

The tremendous loss caused by continuous influx of fungal pests results in long-lasting damage to crop production, its quality and yield. Chemical control is the most widely used method. However, the indiscriminate use of these products leads to problems of increased toxicity and remnants of residues present in the environment and the selection of resistant strains of the pathogens.

Therefore, there is a need in the art to provide an alternate fungicidal combination and a method for effectively controlling phytopathogenic fungi causing diseases in soybean cultivations.

### OBJECT OF THE INVENTION

It is an object of the present invention to provide a fungicidal combination for controlling phytopathogenic fungi in soybean crop.

It is another object of the present invention to provide a method of controlling phytopathogenic fungi in soybean crop.

It is another object of the present invention to provide a fungicidal composition for controlling phytopathogenic fungi in soybean crop.

It is yet another object of the present invention to provide the use of a fungicidal combination for controlling phytopathogenic fungi in soybean crop.

### SUMMARY OF THE INVENTION

The present invention provides a fungicidal combination for controlling phytopathogenic fungi in soybean crop.

In an aspect, the present invention provides a fungicidal combination comprising one or more multisite fungicides for controlling phytopathogenic fungi in soybean crop.

In an aspect, the present invention provides a fungicidal combination comprising at least two multisite fungicides for controlling phytopathogenic fungi in soybean crop.

In another aspect, the present invention provides a fungicidal combination comprising at least two multisite fungicides selected from copper or its salts and sulphur for controlling phytopathogenic fungi in soybean crop.

In another aspect, the present invention provides a fungicidal combination comprising at least two multisite fungicides selected from copper or its salts and sulphur and one or more systemic fungicides for controlling phytopathogenic fungi in soybean crop.

The present invention provides a method of controlling fungal diseases in soybean crop.

In an aspect, the present invention provides a method of controlling fungal diseases comprising applying one or more multisite fungicides to a plant, plant part, locus or propagation material in soyabean crop.

In another aspect, the present invention provides a method of controlling fungal diseases comprising applying at least two multisite fungicides selected from copper or its salts and sulphur to a plant, plant part, locus, or propagation material in a soyabean crop.

In another aspect, the present invention provides a method of controlling fungal diseases comprising applying at least two multisite fungicides selected from copper or its salts and sulphur and one or more systemic fungicides to a plant, plant part, locus, or propagation material in a soyabean crop.

In another aspect, the present invention provides a fungicidal composition comprising;
(i) at least two multisite fungicides selected from copper or its salts and sulphur, and
(ii) at least one agrochemically acceptable excipient.

In another aspect, the present invention provides a fungicidal composition comprising;
(i) at least two multisite fungicides selected from copper or its salts and sulphur,
(ii) one or more systemic fungicides, and
(iii) at least one agrochemically acceptable excipient.

In yet another aspect, the present invention provides the use of a fungicidal combination comprising at least two multisite fungicides selected from copper or its salts and sulphur for controlling phytopathogenic fungi in soybean crop.

In yet another aspect, the present invention provides the use of a fungicidal combination comprising at least two multisite fungicides selected from copper or its salts and sulphur and at least two systemic fungicides for controlling phytopathogenic fungi in soybean crop.

In another aspect, the present disclosure provides a kit. The kit comprises a plurality of components comprising at least one of the ingredients of the fungicidal combination of the present disclosure.

### DETAILED DESCRIPTION OF THE INVENTION

For the purposes of the following detailed description, it is to be understood that the invention may assume various alternative variations, except where expressly specified to the contrary.

Moreover, other than in any operating examples, or where otherwise indicated, all numbers expressing, for example, quantities of materials/ingredients used in the specification are to be understood as being modified in all instances by the term “about”. The term “about” used to qualify the amounts of active components shall be interpreted to mean “approximately” or “reasonably close to” and any statistically insignificant variations therefrom.

As used herein, the terms “comprising” “including,” “having,” “containing,” “involving,” and the like are to be understood to be open-ended, i.e., to mean including but not limited to.

In any aspect or embodiment described hereinbelow, the phrase comprising may be replaced by the phrases “consisting of” or “consisting essentially of”. In these aspects or embodiments, the combination or composition described includes or comprises or consists of or consists essentially of or consists substantially of the specific components recited therein, to the exclusion of other ingredients or excipients not specifically recited therein.

The phrase ‘fungicidally effective amount’ refers to an amount of the fungicide that kills or inhibits the phytopathogenic disease for which control is desired, in an amount not significantly toxic to the plant being treated.

The term ‘disease control’ as used herein denotes control and prevention of a disease. Controlling effects include all deviation from natural development, for example: killing, retardation, inhibition or decrease of the fugal disease.

The term “plants” refers to all physical parts of a plant, including seeds, seedlings, saplings, roots, tubers, stems, stalks, foliage and fruits.

The term “locus” of a plant as used herein is intended to embrace the place on which the plants are growing, where the plant propagation materials of the plants are sown or where the plant propagation materials of the plants will be placed into the soil.

The term “plant propagation material” is understood to denote generative parts of a plant, such as seeds, vegetative material such as cuttings or tubers, roots, fruits, tubers, bulbs, rhizomes and parts of plants, germinated plants and young plants which are to be transplanted after germination or after emergence from the soil. These young plants may be protected before transplantation by a total or partial treatment by immersion.

The term “agriculturally acceptable amount of active” refers to an amount of an active that kills or inhibits the plant disease for which control is desired, in an amount not significantly toxic to the plant being treated.

As used herein, the term % disease severity refers to the percentage decay observed in the crops in terms of the percentage of relevant host tissues covered by lesions or damaged by the disease in crops. Severity results from the number and size of the lesions. The % severity indicates the extent of damage caused by the disease.

As used herein, the term % disease control refers to the % control and prevention of a disease in crops.

The term “g ai/L” as used herein denotes the concentration of the respective active ingredient in “grams” present “per litre” of the composition or combination.

The term “g ai/h” as used herein denotes the concentration of the respective active ingredient in “grams” applied “per hectare” of the crop field.

Each of the aspects described above may have one or more embodiments.

Each of the embodiments described hereinafter may apply to one or all the aspects described hereinabove. These embodiments are intended to be read as being preferred features of one or all the aspects described hereinabove. Each of the embodiments described hereinafter applies to each of the aspects described hereinabove individually.

By way of the present disclosure, the present inventors have successfully developed a fungicidal combination to effectively inhibit the growth of fungal phytopathogens causing fungal diseases observed in soyabean cultivations such as Asian Soyabean Rust (ASR) by Phakopsora pachyrhizi, powdery mildew by Erysiphe diffusa, Frogeye leaf spot (FLS) caused by Cercospora sojina, brown spot caused by Septoria glycines. Diverse phytopathogens are known to cause diseases in soybean cultivations. The present inventors have extended tremendous inventive ingenuity to arrive at the present fungicidal combination comprising at least two multisite fungicides to obtain inhibition of fungal phytopathogens, particularly, Phakopsora pachyrhizi causing Asian Soyabean Rust (ASR), Erysiphe diffusa causing powdery mildew in soybean, amongst other fungal phytopathogens infesting soyabean cultivations. Accordingly, the present inventors have provided a fungicidal combination comprising a copper fungicide and sulphur to exert inhibitory activity against fungal phytopathogens in soybean crop.

In an embodiment, the present invention provides a fungicidal combination comprising one or more multisite fungicides for controlling phytopathogenic fungi in soybean crop.

In an embodiment, the present invention provides a fungicidal combination comprising at least two multisite fungicides for controlling phytopathogenic fungi-Phakopsora pachyrhizi causing Asian Soyabean Rust (ASR), Erysiphe diffusa causing powdery mildew, Cercospora sojina causing Frogeye leaf spot (FLS), Septoria glycines . . . causing brown spot in soybean crop.

In an embodiment, the multi-site fungicides are selected from the group comprising copper or its salts, sulphur, dithiocarbamates, phthalimides, chloronitriles, sulfamides, bis-guanidines, triazines, quinones, quinoxalines, maleimide and thiocarbamates.

In a preferred embodiment, the multi-site fungicide comprises copper or its salts.

In an embodiment, the copper compound is a copper salt.

In an embodiment, the copper compound is a copper salt selected from the group comprising copper sulphate, tribasic copper sulphate, dibasic copper sulphate, copper oxychloride, copper chloride, copper oxide, cupric oxide, copper nitrate, copper perchlorate, copper bromide, copper hydroxide, copper iodide, cupric acetate, or copper sulfate pentahydrate.

In a preferred embodiment, the copper compound is tribasic copper sulphate.

In an embodiment, the copper compound is copper sulphate.

In a preferred embodiment, the multi-site fungicide is sulphur.

In an embodiment, the sulphur is particulate sulfur having a particle size distribution based on diameters of D₉₀ which is <100 microns.

In an embodiment, the sulphur is particulate sulfur having a particle size distribution based on diameters of D₉₀ which is <50 microns.

In an embodiment, the sulphur is particulate sulfur having a particle size distribution based on diameters of D₉₀ which is <25 microns.

In an embodiment, the sulphur is a particulate sulfur having a particle size distribution based on diameters of Deo between about 1 and 3 microns, which by itself exhibits a significantly improved rain wash resistance and reduced phytotoxicity to leaf surfaces. Even more surprisingly, such suspension concentrate having a particle size distribution based on diameters D₉₀ between about 1 and 3 microns, interchangeably alone or in combination with a second multi-site contact fungicide, exhibits significantly improved efficacy against fungal infestations.

The particle size distribution of the particulate sulphur component of the present invention has a D₉₀ of about 1.2 microns.

In an embodiment, one of the multisite fungicides of the present invention may be a dithiocarbamate fungicide selected from the group comprising amobam, ferbam, mancozeb, maneb, metiram, propineb, thiram, zinc thiazole, zineb and ziram.

In an embodiment, one of the multisite fungicides of the present invention may be a phthalimide fungicide selected from the group comprising captan, captafol and folpet.

In an embodiment, one of the multisite fungicides of the present invention may be chlorothalonil.

In an embodiment, one of the multisite fungicides of the present invention may be a sulfamide fungicide selected from dichlofluanid and tolylfluanid.

In an embodiment, one of the multisite fungicides of the present invention may be a bis-guanidine fungicide selected from guazatine and iminoctadine.

In an embodiment, one of the multisite fungicides of the present invention may be a triazine fungicide selected from anilazine.

In an embodiment, one of the multisite fungicides of the present invention may be a quinone fungicide selected from dithianon.

In an embodiment, one of the multisite fungicides of the present invention may be a quinoxaline fungicide selected from chinomethionat or quinomethionate.

In an embodiment, one of the multisite fungicides of the present invention may be a maleimide fungicide selected from fluoroimide.

In an embodiment, one of the multisite fungicides of the present invention may be a thiocarbamate fungicide selected from methasulfocarb.

In a preferred embodiment, the present invention provides a fungicidal combination for controlling fungal infestation in soybean crop, said combination comprising one or more multi-site fungicides selected from a copper salt, and sulphur.

In a preferred embodiment, the present invention provides a fungicidal combination for controlling Phakopsora pachyrhizi causing Asian Soyabean Rust (ASR) in soybean, said combination comprising one or more multi-site fungicides selected from a copper salt and sulphur.

In a preferred embodiment, the present invention provides a fungicidal combination for controlling Erysiphe diffusa causing powdery mildew in soybean, said combination comprising one or more multi-site fungicides selected from a copper salt, and sulphur.

It is required to be noted that the order of the fungicide in the combination is not necessarily the same as described in the preferred embodiments above and is interchangeable.

In an embodiment, the present invention provides a fungicidal combination comprising at least two multisite fungicides selected from copper or its salts and sulphur for controlling Phakopsora pachyrhizi causing Asian Soyabean Rust (ASR) in soybean.

In an embodiment, the present invention provides a fungicidal combination comprising at least two multisite fungicides selected from copper or its salts and sulphur for controlling Erysiphe diffusa causing powdery mildew in soybean.

In an embodiment, the present invention provides a fungicidal combination comprising at least two multisite fungicides, wherein the first multisite fungicide is tribasic copper sulphate and the second multisite fungicide is sulphur for controlling phytopathogenic fungal infestation in soyabean.

In an embodiment, the present invention provides a fungicidal combination comprising at least two multisite fungicides, wherein the first multisite fungicide is tribasic copper sulphate and the second multisite fungicide is sulphur for controlling Phakopsora pachyrhizi causing Asian Soyabean Rust (ASR) in soybean.

In an embodiment, the present invention provides a fungicidal combination comprising at least two multisite fungicides, wherein the first multisite fungicide is tribasic copper sulphate and the second multisite fungicide is sulphur for controlling Erysiphe diffusa causing powdery mildew in soybean.

In an embodiment, the present invention provides a fungicidal combination comprising at least two multisite fungicides selected from copper or its salts and a dithiocarbamate fungicide for controlling fungal infestation in soybean.

In an embodiment, the present invention provides a fungicidal combination comprising at least two multisite fungicides selected from tribasic copper sulphate and mancozeb for controlling Phakopsora pachyrhizi causing Asian Soyabean Rust (ASR) in soybean.

In an embodiment, the present invention provides a fungicidal combination comprising at least two multisite fungicides selected from tribasic copper sulphate and mancozeb for controlling Erysiphe diffusa causing powdery mildew in soybean.

In an embodiment, the present invention provides a fungicidal combination comprising at least two multisite fungicides selected from sulphur and a dithiocarbamate for controlling phytopathogenic fungi in soybean cultivations.

In an embodiment, the present invention provides a fungicidal combination comprising at least two multisite fungicides selected from sulphur and mancozeb for controlling Phakopsora pachyrhizi causing Asian Soyabean Rust (ASR) in soybean crop.

In an embodiment, the present invention provides a fungicidal combination comprising at least two multisite fungicides selected from sulphur and mancozeb for controlling Erysiphe diffusa causing powdery mildew in soybean crop.

In an embodiment, the present invention provides a fungicidal combination for controlling phytopathogenic fungi in soybean cultivations, said combination comprising a first multi-site fungicide selected from a copper salt, and a second multi-site fungicide compound selected from sulphur, wherein the weight ratio of the copper salt to sulphur is ranging from 1:15 to 15:1.

In an embodiment, the present invention provides a fungicidal combination for controlling phytopathogenic fungi in soybean cultivations, said combination comprising a first multi-site fungicide selected from a copper salt, and a second multi-site fungicide compound selected from sulphur, wherein the weight ratio of the copper salt to sulphur is ranging from 1:1 to 1:15.

In an embodiment, the present invention provides a fungicidal combination for controlling phytopathogenic fungi in soybean cultivations, said combination comprising a first multi-site fungicide selected from a copper salt, and a second multi-site fungicide compound selected from sulphur, wherein the weight ratio of the copper salt to sulphur is ranging from 1:1 to 1:10.

In an embodiment, the present invention provides a fungicidal combination for controlling phytopathogenic fungi in soybean cultivations, said combination comprising a first multi-site fungicide selected from a copper salt, and a second multi-site fungicide compound selected from sulphur, wherein the weight ratio of the copper salt to sulphur is 1:8.

In an embodiment, the present invention provides a fungicidal combination for controlling phytopathogenic fungi in soybean cultivations, said combination comprising tribasic copper sulphate and a sulphur compound, wherein the weight ratio of tribasic copper sulphate to sulphur is ranging from 1:15 to 15:1.

In an embodiment, the present invention provides a fungicidal combination for controlling phytopathogenic fungi in soybean cultivations, said combination comprising tribasic copper sulphate and a sulphur compound, wherein the weight ratio of tribasic copper sulphate to sulphur is ranging from 1:1 to 1:15.

In an embodiment, the present invention provides a fungicidal combination for controlling phytopathogenic fungi in soybean cultivations, said combination comprising tribasic copper sulphate and a sulphur compound, wherein the weight ratio of tribasic copper sulphate to sulphur is ranging from 1:1 to 1:10.

In an embodiment, the present invention provides a fungicidal combination for controlling phytopathogenic fungi in soybean cultivations, said combination comprising tribasic copper sulphate and a sulphur compound, wherein the weight ratio of tribasic copper sulphate to sulphur is 1:8.

In a preferred embodiment, the present invention provides a fungicidal combination for controlling Phakopsora pachyrhizi causing Asian Soyabean Rust (ASR) in soybean, said combination comprising a first multi-site fungicide selected from a copper salt, and a second multi-site fungicide compound selected from sulphur, wherein the weight ratio of copper or its salts to sulphur is ranging from 1:1 to 1:15.

In a preferred embodiment, the present invention provides a fungicidal combination for controlling Phakopsora pachyrhizi causing Asian Soyabean Rust (ASR) in soybean, said combination comprising a first multi-site fungicide selected from a copper salt, and a second multi-site fungicide compound selected from sulphur, wherein the weight ratio of copper or its salts to sulphur is ranging from 1:1 to 1:10.

In a more preferred embodiment, the present invention provides a fungicidal combination for controlling Phakopsora pachyrhizi causing Asian Soyabean Rust (ASR), in soybean cultivations, said combination comprising a first multi-site fungicide selected from a copper salt, and a second multi-site fungicide compound selected from sulphur, wherein the weight ratio of copper or its salts to sulphur is 1:8.

In a preferred embodiment, the present invention provides a fungicidal combination for controlling Erysiphe diffusa causing powdery mildew in soybean, said combination comprising a first multi-site fungicide selected from a copper salt, and a second multi-site fungicide compound selected from sulphur, wherein the weight ratio of copper or its salts to sulphur is ranging from 1:1 to 1:15.

In a preferred embodiment, the present invention provides a fungicidal combination for controlling Erysiphe diffusa causing powdery mildew in soybean, said combination comprising a first multi-site fungicide selected from a copper salt, and a second multi-site fungicide compound selected from sulphur, wherein the weight ratio of copper or its salts to sulphur is ranging from 1:1 to 1:10.

In a more preferred embodiment, the present invention provides a fungicidal combination for controlling Erysiphe diffusa causing powdery mildew in soybean cultivations, said combination comprising a first multi-site fungicide selected from a copper salt, and a second multi-site fungicide compound selected from sulphur, wherein the weight ratio of the copper or its salts to sulphur is 1:8.

In an embodiment, the present invention provides a fungicidal combination for controlling Phakopsora pachyrhizi causing Asian Soyabean Rust (ASR), Erysiphe diffusa causing powdery mildew in soybean, said combination comprising a first multi-site fungicide selected from a copper salt, and a second multi-site fungicide compound selected from a dithiocarbamate fungicide, wherein the weight ratio of the copper salt to the dithiocarbamate fungicide is ranging from 1:1 to 1:15.

In an embodiment, the present invention provides a fungicidal combination for controlling Phakopsora pachyrhizi causing Asian Soyabean Rust (ASR), Erysiphe diffusa causing powdery mildew in soybean cultivations, said combination comprising a first multi-site fungicide selected from a copper salt, and a second multi-site fungicide compound selected from a dithiocarbamate fungicide, wherein the weight ratio of the copper salt to the dithiocarbamate fungicide is ranging from 1:1 to 1:10.

In an embodiment, the present invention provides a fungicidal combination for controlling Phakopsora pachyrhizi causing Asian Soyabean Rust (ASR), Erysiphe diffusa causing powdery mildew in soybean, said combination comprising tribasic copper sulphate and mancozeb, wherein the weight ratio of tribasic copper sulphate and mancozeb is ranging from 1:5 to 1:10.

In an embodiment, the present invention provides a fungicidal combination for controlling Phakopsora pachyrhizi causing Asian Soyabean Rust (ASR), Erysiphe diffusa causing powdery mildew in soybean cultivations, said combination comprising tribasic copper sulphate and mancozeb, wherein the weight ratio of the tribasic copper sulphate and mancozeb is 1:8.

In an embodiment, the present invention provides a fungicidal combination comprising at least two multisite fungicides and at least one additional fungicide for controlling phytopathogenic fungi in soybean cultivations.

The fungal diseases in soyabean covered within the scope of the present invention include Phakopsora pachyrhizi causing Asian Soyabean Rust (ASR), Erysiphe diffusa causing powdery mildew, Cercospora sojina causing Frogeye leaf spot (FLS), Septoria glycines . . . causing brown spot, Phytophthora root and stem rot, pod and stem blight, brown spot, downy mildew, Cercospora leaf blight and purple seed stain, and Sclerotinia stem rot (white mold).

In a further embodiment, the present invention provides a fungicidal combination comprising at least two multisite fungicides and at least one additional fungicide selected from the group comprising morpholine fungicides, triazole fungicides, acylamino acid fungicides, anilide fungicides, antibiotic fungicides, strobilurin fungicides, aromatic fungicides, arsenical fungicides, aryl phenyl ketone fungicides, benzimidazole fungicides, benzimidazole precursor fungicides, benzothiazole fungicides, bridged diphenyl fungicides, carbamate fungicides, conazole fungicides, copper fungicides, dicarboximide fungicides, dinitrophenol fungicides, dithiocarbamate fungicides, dithiolane fungicides, hydrazide fungicides, imidazole fungicides, inorganic fungicides, organophosphorus fungicides, organotin fungicides, oxathiin fungicides, oxazole fungicides, pyrimidine fungicides, pyrrole fungicides, quinoline fungicides, quinone fungicides, quinoxaline fungicides, thiadiazole fungicides, thiazole fungicides, thiazolidine fungicides, thiocarbamate fungicides, thiophene fungicides, triazine fungicides, triazolopyrimidine fungicides, urea fungicides, zinc fungicides, unclassified fungicides and mixtures thereof.

In an embodiment, the additional fungicide is a systemic fungicide. As used herein, the term “systemic fungicide” refers to a fungicide which is absorbed by the foliage and roots and translocated upward internally by the plant through the xylem.

In an embodiment, the present invention provides a fungicidal combination comprising at least two multisite fungicides and at least one systemic fungicide for controlling phytopathogenic fungi-Phakopsora pachyrhizi causing Asian Soyabean Rust (ASR), Erysiphe diffusa causing powdery mildew in soybean cultivations.

In an embodiment, the present invention provides a fungicidal combination comprising at least two multisite fungicides and at least two systemic fungicides for controlling phytopathogenic fungi—Phakopsora pachyrhizi causing Asian Soyabean Rust (ASR), Erysiphe diffusa causing powdery mildew, Cercospora sojina causing Frogeye leaf spot (FLS), Septoria glycines . . . causing brown spot, Phytophthora root and stem rot, pod and stem blight, brown spot, downy mildew, Cercospora leaf blight and purple seed stain, and Sclerotinia stem rot (white mold) in soybean cultivations.

In an embodiment, the systemic fungicides which are particularly suitable for use in a combination according to the present invention belong to the following groups: acylalanines (metalaxyl, metalaxyl-M), benzimidazoles (benomyl, carbendazim, thiabandazole or thiophanate methyl), oxanthiins (carboxin or oxycarboxyn), organophosphates (fosetyl-AI), pyrimidines (dimethirimol, ethirimol, bupirimate, fenarimol, cyprodinil or nuarimol), triazoles (conazoles or imidazoles—such as triadimefon, bitertanol, difenoconazole, propiconazole, myclobutanil, cyproconazole, prochloraze, bromuconazole, epoxiconazole, metconazole or tebuconazole), strobilurins (QoI fungicides, azoxystrobin, trifloxystrobin, pyraclostrobin, dimoxystrobin or kresoxim methyl), triazolinthiones (prothioconazole), succinate dehydrogenase inhibitor (SDHI) fungicides (benzovindiflupyr, bixafen, boscalid, carboxin, fluaxapyroxad, fluopyram, isopyrazam, penthiopyrador sedaxane), piperidines (fenpropidin), organochlorine (chlorothalonil), morpholine analogue fungicides (fenpropimorph, fenpropidin or amorolfine), sulphur fungicide, or a combination of any thereof.

In an embodiment, the present invention provides a fungicidal combination comprising at least two multisite fungicides and at least one systemic fungicide for controlling phytopathogenic fungi in soybean cultivations.

In an embodiment, the present invention provides a fungicidal combination comprising a tribasic copper sulphate, sulphur and metalaxyl or its isomers, for controlling phytopathogenic fungi in soybean cultivations.

In an embodiment, the present invention provides a fungicidal combination comprising a tribasic copper sulphate, sulphur and carboxin, for controlling phytopathogenic fungi in soybean cultivations.

In an embodiment, the present invention provides a fungicidal combination comprising a tribasic copper sulphate, sulphur and tebuconazole, for controlling phytopathogenic fungi in soybean cultivations.

In an embodiment, the present invention provides a fungicidal combination comprising a tribasic copper sulphate, sulphur and difenoconazole, for controlling phytopathogenic fungi in soybean cultivations.

In an embodiment, the present invention provides a fungicidal combination comprising a tribasic copper sulphate, sulphur and prothioconazole, for controlling phytopathogenic fungi in soybean cultivations.

In an embodiment, the present invention provides a fungicidal combination comprising a tribasic copper sulphate, sulphur and azoxystrobin, for controlling phytopathogenic fungi in soybean cultivations.

In an embodiment, the present invention provides a fungicidal combination comprising a tribasic copper sulphate, sulphur and trifloxystrobin, for controlling phytopathogenic fungi in soybean crop.

The combinations of the present invention may be provided as a pre-mix composition or a kit of parts such that individual actives may be mixed before spraying. Alternatively, the kit of parts may contain at least two multisite fungicides comprising a combination of copper or its salts and sulphur pre-mixed and an optional third active which may be admixed with an adjuvant such that the two components may be tank mixed before spraying.

Therefore, in an embodiment, the present invention provides a kit comprising a fungicidal combination comprising sulphur and tribasic copper sulphate.

In another embodiment, the present invention provides a kit comprising a fungicidal combination comprising sulphur and a tribasic copper sulphate; and an optional third fungicide selected from morpholine fungicides, triazole fungicides, acylamino acid fungicides, anilide fungicides, antibiotic fungicides, strobilurin fungicides, aromatic fungicides, arsenical fungicides, aryl phenyl ketone fungicides, benzimidazole fungicides, benzimidazole precursor fungicides, benzothiazole fungicides, bridged diphenyl fungicides, carbamate fungicides, conazole fungicides, copper fungicides, dicarboximide fungicides, dinitrophenol fungicides, dithiocarbamate fungicides, dithiolane fungicides, hydrazide fungicides, imidazole fungicides, inorganic fungicides, organophosphorus fungicides, organotin fungicides, oxathiin fungicides, oxazole fungicides, pyrimidine fungicides, pyrrole fungicides, quinoline fungicides, quinone fungicides, quinoxaline fungicides, thiadiazole fungicides, thiazole fungicides, thiazolidine fungicides, thiocarbamate fungicides, thiophene fungicides, triazine fungicides, triazolopyrimidine fungicides, urea fungicides, zinc fungicides, unclassified fungicides and mixtures thereof.

The combinations of the present disclosure may be sold as a pre-mix composition or a kit of parts such that individual actives may be mixed before spraying. Alternatively, the kit of parts may contain at least two multi-site fungicides pre-mixed and the third active may be admixed with an adjuvant such that the two components may be tank mixed before spraying.

In an embodiment, the systemic fungicide may be a single fungicide or a combination of one or more systemic fungicides.

In an embodiment, the systemic fungicide is a combination of at least two fungicides.

In an embodiment, the systemic fungicides in the combinations may be selected from nucleic acid synthesis inhibitor, cytoskeleton and motor protein inhibitors, amino acids and protein synthesis inhibitors, respiration process inhibitors, signal transduction inhibitors, lipid synthesis and membrane integrity disruptors, sterol biosynthesis inhibitors, melanin synthesis inhibitors, cell wall biosynthesis inhibitors, melanin synthesis inhibitor in cell wall, host plant defence inductors, fungicides with unknown modes of action, fungicide with no classification, or biologicals with multiple mode of action.

Thus, in an embodiment, the nucleic acid synthesis inhibitor fungicides may be selected from acylalanines such as benalaxyl, benalaxyl-M (kiralaxyl), furalaxyl, metalaxyl, metalaxyl-M (mefenoxam), oxazolidinones such as oxadixyl, butyrolactones such as ofurace, hydroxy-(2-amino-) pyrimidines such as bupirimate, dimethirimol, ethirimol, isoxazoles such as hymexazole, isothiazolones such as octhilinone, carboxylic acids such as oxolinic acid.

In an embodiment, the cytoskeleton and motor protein inhibitors may be benzimidazoles such as benomyl, carbendazim, fuberidazole, thiabendazole, thiophanates such as thiophanate, thiophanate-methyl, N-phenyl carbamates such as diethofencarb, toluamides such as zoxamide, thiazole carboxamides such as ethaboxam, phenylureas such as pencycuron, benzamides such as fluopicolide, cyanoacrylates such as phenamacril.

In an embodiment, the respiration process inhibitor fungicides may be selected from pyrimidinamines such diflumetorim, pyrazole-5-carboxamides such as tolfenpyrad, strobilurins such as azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, dimoxystrobin, fenaminostrobin, metominostrobin, trifloxystrobin, famoxadone, fluoxastrobin, fenamidone, pyribencarb and mixtures thereof, oxazolidine-diones such as famoxadone, Imidazolinones such as fenamidone, benzyl-carbamates such as pyribencarb, N-methoxy-(phenyl-ethyl)-pyrazole-carboxamides such as Pyrimidinamines such as diflumetorim, cyano-imidazole such as cyazofamid, sulfamoyl-triazole such as amisulbrom, dinitrophenyl crotonates such as binapacryl, meptyldinocap, dinocap, 2,6-dinitro-anilines such as fluazinam, pyr.-hydrazones such as ferimzone, tri-phenyl tin compounds such as fentin acetate, fentin chloride, fentin hydroxide, thiophene-carboxamides such as silthiofam, triazolo-pyrimidylamine such as ametoctradin.

In an embodiment, amino acids and protein synthesis inhibitor fungicides may be selected from anilino-pyrimidines such as cyprodinil, mepanipyrim, pyrimethanil, antibiotic fungicides such as blasticidin-S, kasugamycin, streptomycin, oxytetracycline and the like.

In an embodiment, signal transduction inhibitor fungicides may be selected from aryloxyquinolines such as quinoxyfen, quinazolinones such as proquinazid, phenylpyrroles such as fenpiclonil, fludioxonil, dicarboximides such as chlozolinate, dimethachlone, iprodione, procymidone and vinclozolin.

In an embodiment, the third fungicide may be selected from lipid synthesis and membrane integrity disruptors such as phosphoro-thiolates such as edifenphos, Iprobenfos, pyrazophos, dithiolanes such as isoprothiolane, aromatic hydrocarbons such as biphenyl, chloroneb, dicloran, quintozene (PCNB), tecnazene (TCNB), tolclofos-methyl and the like, 1,2,4-thiadiazoles such as etridiazole, carbamates such as iodocarb, propamocarb, prothiocarb and the like.

Thus in an embodiment, the sterol biosynthesis inhibitors may be selected from triazoles such as azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, Ipconazole, metconazole, myclobutanil, penconazole, Propiconazole, simeconazole, tebuconazole, tetraconazole, triadimefon, triadimenol, triticonazole, prothioconazole, piperazines such as triforine, pyridines such as pyrifenox, pyrisoxazole, pyrimidines such as fenarimol, nuarimol imidazoles such as imazalil, oxpoconazole, pefurazoate, prochloraz, triflumizole, morpholines such as aldimorph, dodemorph, fenpropimorph, tridemorph and the like, piperidines such as fenpropidin, piperalin, spiroketal-amines such as spiroxamine, hydroxyanilides such as fenhexamid, amino-pyrazolinones such as fenpyrazamine, thiocarbamates such as pyributicarb, allylamines such as naftifine, terbinafine and mixtures thereof.

In an embodiment, cell wall biosynthesis inhibitor fungicides may be selected from peptidyl pyrimidine nucleoside fungicides such as polyoxin, cinnamic acid amides such as dimethomorph, flumorph, pyrimorph, valinamide carbamates such as benthiavalicarb, iprovalicarb, valifenalate, mandelic acid amides such as mandipropamid and mixtures thereof.

In an embodiment, melanin synthesis inhibitor fungicide may be selected from isobenzo-furanone such as fthalide, pyrrolo-quinolinones such as pyroquilon, triazolobenzo-thiazoles such as tricyclazole, cyclopropane-carboxamides such as carpropamid, carboxamides such as diclocymet, propionamides such as fenoxanil, trifluoroethyl-carbamates such as tolprocarb, and mixtures thereof.

In an embodiment, host plant defence inductors fungicides may be selected from benzo-thiadiazoles such as acibenzolar-S-methyl, benzisothiazoles such as probenazole, thiadiazole-carboxamides such as tiadinil, isotianil, polysaccharides such as laminarin, and mixtures thereof.

In another embodiment, the ergosterol biosynthesis inhibitors may be selected from prothioconazole, tebuconazole, hexaconazole, cyroconazole or epoxiconazole.

In an embodiment, the systemic fungicide may be a Quinone outside (Qo) inhibitor fungicide selected from azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, dimoxystrobin, fenaminostrobin, metominostrobin, trifloxystrobin, famoxadone, fluoxastrobin, fenamidone, pyribencarb and mixtures thereof.

In an embodiment, the Quinone outside (Qo) inhibitor fungicide may be selected from azoxystrobin, picoxystrobin, kresoxim-methyl, pyraclostrobin and trifloxystrobin.

In an embodiment, the third systemic fungicide is selected from a quinone outside inhibitor, quinone inside inhibitor, demethylation inhibitor, and/or succinate dehydrogenase inhibitor; wherein:
(i) the quinone outside inhibitor is selected from fenamidone, famoxadone, and a strobilurin fungicide selected from the group consisting of azoxystrobin, mandestrobin, coumoxystrobin, enoxastrobin, flufenoxystrobin, pyraoxystrobin, dimoxystrobin, enestrobin, fluoxastrobin, kresoxim-methyl, metominostrobin, orysastrobin, picoxystrobin, pyrametostrobin, triclopyricarb, fenaminstrobin, pyraclostrobin and trifloxystrobin;
(ii) the demethylation inhibitor is selected from triflumizole, triforine, pyridinitrile, pyrifenox, fenarimol, nuarimol, triarimol and a conazole fungicide selected from the group consisting of climbazole, clotrimazole, imazalil, oxpoconazole, prochloraz, prochloraz-manganese, triflumizole, azaconazole, bitertanol, bromuconazole, cyproconazole, diclobutrazol, difenoconazole, diniconazole, diniconazole-M, epoxiconazole, etaconazole, fenbuconazole, fluotrimazole, fluquinconazole, flusilazole, flutriafol, furconazole, furconazole-cis, hexaconazole, imibenconazole, ipconazole, metconazole, myclobutanil, pencoconazole, propiconazole, prothioconazole, quinconazole, simeconazole, tebuconazole, tetraconazole, triadimefon, triadimenol, triticonazole, uniconazole, perfurazoate and uniconazole-P;
(iii) the quinone inside inhibitor selected from cyazofamid and amisulbrom; and
(iv) a succinate dehydrogenase inhibitor selected from the group consisting of benodanil, flutolanil, mepronil, fluopyram, fenfuram, carboxin, oxycarboxin, thifluzamide, bixafen, fluxapyroxad, furametpyr, isopyrazam, penflufen, penthiopyrad, sedaxane and boscalid.

In an embodiment, the present invention provides use of a fungicidal combination comprising one or more multisite fungicides for controlling fungal infestation in soybean cultivations.

In a preferred embodiment, the present invention provides the use of a fungicidal combination for controlling growth of phytopathogenic fungi in soybean cultivations, the said combination comprising at least two multi-site fungicides selected from copper or its salts or sulphur.

In an embodiment, the present invention provides use of a fungicidal combination comprising one or more multisite fungicides for controlling phytopathogenic fungi in soybean cultivations for controlling phytopathogenic fungal diseases in soyabean cultivations including Asian Soyabean Rust (ASR) by Phakopsora pachyrhizi, powdery mildew by Erysiphe diffusa, Frogeye leaf spot (FLS) caused by the fungus, Cercospora sojina, brown spot caused by Septoria glycines, purple seed stain caused by Cercospora kikuchii, sphaceloma scad caused by Elsinoe glycines, pod and stem blight caused by Diaporthe phaseolorum var. sojae, amongst several other diseases in soyabean.

In an embodiment, the present invention provides use of a fungicidal combination for controlling phytopathogenic fungi in soybean cultivations, said combination comprising a first multi-site fungicide selected from a copper compound, and a second multi-site fungicide compound selected from sulphur, wherein the weight ratio of the copper compound to sulphur is ranging from 1:1 to 1:15.

In a preferred embodiment, the present invention provides use of a fungicidal combination for controlling phytopathogenic fungi in soybean cultivations, said combination comprising a first multi-site fungicide selected from a copper compound, and a second multi-site fungicide compound selected from sulphur, wherein the weight ratio of the copper compound to sulphur is ranging from 1:1 to 1:10.

In a more preferred embodiment, the present invention provides use of a fungicidal combination for controlling phytopathogenic fungi in soybean cultivations, said combination comprising a first multi-site fungicide selected from a copper compound, and a second multi-site fungicide compound selected from sulphur, wherein the weight ratio of the copper compound to sulphur is 1:8.

In an embodiment, the present invention provides use of a fungicidal combination for controlling phytopathogenic fungi in soybean cultivations, said combination comprising copper or its salts, and a second multi-site fungicide compound selected from sulphur, wherein the weight ratio of copper or its salts to sulphur is ranging from 1:1 to 1:15.

In an embodiment, the present invention provides use of a fungicidal combination for controlling phytopathogenic fungi in soybean cultivations, said combination comprising copper or its salts, and a second multi-site fungicide compound selected from sulphur, wherein the weight ratio of copper or its salts to sulphur is ranging from 1:1 to 1:10.

In an embodiment, the present invention provides use of a fungicidal combination for controlling phytopathogenic fungi in soybean cultivations, said combination comprising copper or its salts, and a second multi-site fungicide compound selected from sulphur, wherein the weight ratio of the copper or its salts to sulphur is 1:8.

In an embodiment, the present invention provides use of a fungicidal combination for controlling phytopathogenic fungi in soybean cultivations, said combination comprising tribasic copper sulphate and sulphur, wherein the weight ratio of tribasic copper sulphate to sulphur is ranging from 1:1 to 1:15.

In an embodiment, the present invention provides use of a fungicidal combination for controlling phytopathogenic fungi in soybean cultivations, said combination comprising tribasic copper sulphate and sulphur, wherein the weight ratio of tribasic copper sulphate to sulphur is ranging from 1:1 to 1:10.

In an embodiment, the present invention provides use of a fungicidal combination for controlling phytopathogenic fungi in soybean cultivations, said combination comprising tribasic copper sulphate and sulphur, wherein the weight ratio of tribasic copper sulphate to sulphur is 1:8.

In an embodiment, the present invention provides a fungicidal composition comprising one or more multisite fungicides and one or more agrochemically acceptable excipients for controlling phytopathogenic fungi in soybean cultivation.

In an embodiment, the present invention provides a fungicidal composition comprising at least two multisite fungicides, and at least one agrochemically acceptable excipient for controlling phytopathogenic fungi in soybean cultivations.

In a preferred embodiment, the present invention provides a fungicidal composition comprising;
(i) a first multi-site fungicide selected from a copper compound,
(ii) a second multi-site fungicide compound selected from sulphur, and
(iii) at least one agrochemically acceptable excipient.

In an embodiment, the present invention provides a fungicidal composition comprising at least two multisite fungicides selected from copper or its salts and sulphur, at least one agrochemically acceptable excipients for controlling phytopathogenic fungi in soybean cultivations.

In an embodiment, the present invention provides a fungicidal composition for controlling phytopathogenic fungi in soybean cultivations, said composition comprising at least two multisite fungicides selected from copper or its salts and sulphur, wherein the concentration of the copper or its salts is ranging from 1 g/kg to 200 g/kg and the concentration of sulphur is ranging from 100 to 800 g/kg.

In an embodiment, the present invention provides a fungicidal composition for controlling phytopathogenic fungi in soybean cultivations, said composition comprising at least two multisite fungicides selected from copper or its salts and sulphur, wherein the concentration of the copper or its salts is ranging from 10 g/kg to 100 g/kg and the concentration of sulphur is ranging from 200 to 700 g/kg.

In an embodiment, the present invention provides a fungicidal composition for controlling phytopathogenic fungi in soybean cultivations, said composition comprising at least two multisite fungicides selected from copper or its salts and sulphur, wherein the concentration of the copper or its salts is 80 g/kg and the concentration of sulphur is 640 g/kg.

In an embodiment, the present invention provides a fungicidal composition for controlling phytopathogenic fungi in soybean cultivations, said composition comprising at least two multisite fungicides selected from a tribasic copper sulphate and sulphur, wherein the concentration of the tribasic copper sulphate is 80 g/kg and the concentration of sulphur is 640 g/kg.

In an embodiment, the present invention provides a fungicidal composition comprising at least two multisite fungicides selected from copper or its salts and a dithiocarbamate fungicide for controlling phytopathogenic fungi in soybean cultivations.

In an embodiment, the present invention provides a fungicidal composition comprising at least two multisite fungicides selected from tribasic copper sulphate and mancozeb for controlling phytopathogenic fungi in soybean cultivations.

In an embodiment, the present invention provides a fungicidal composition comprising at least two multisite fungicides selected from sulphur and a dithiocarbamate for controlling phytopathogenic fungi in soybean cultivations.

In an embodiment, the present invention provides a fungicidal composition comprising at least two multisite fungicides selected from sulphur and mancozeb for controlling phytopathogenic fungi in soybean cultivations.

In a preferred embodiment, the present invention provides a fungicidal composition comprising;
(i) a first multi-site fungicide selected from a copper compound,
(ii) a second multi-site fungicide compound selected from sulphur, and
(iii) an agriculturally acceptable excipient.

In an embodiment, the compositions of the present invention may typically be produced by mixing the actives in the composition with an inert carrier, and adding surfactants and other adjuvants and carriers as needed and formulated into solid, or liquid formulations, including but not limited to wettable powders, granules, dusts, Soluble (liquid) concentrates, suspension concentrates, oil in water emulsion, water in oil emulsion, emulsifiable concentrates, capsule suspensions, ZC formulations, oil dispersions or other known formulation types. The composition may also be used for treatment of a plant propagation material such as seeds etc. The combinations of the present disclosure may be formulated in the form of a composition.

Examples of the solid carrier used in formulation include fine powders or granules such as minerals such as kaolin clay, attapulgite clay, bentonite, montmorillonite, acid white clay, pyrophyllite, talc, diatomaceous earth and calcite; natural organic materials such as corn rachis powder and walnut husk powder; synthetic organic materials such as urea; salts such as calcium carbonate and ammonium sulfate; synthetic inorganic materials such as synthetic hydrated silicon oxide; and as a liquid carrier, aromatic hydrocarbons such as xylene, alkylbenzene and methylnaphthalene; alcohols such as 2-propanol, ethyleneglycol, propylene glycol, and ethylene glycol monoethyl ether; ketones such as acetone, cyclohexanone and isophorone; vegetable oil such as soybean oil and cotton seed oil; petroleum aliphatic hydrocarbons, esters, dimethylsulfoxide, acetonitrile and water.

Examples of the surfactant include anionic surfactants such as alkyl sulfate ester salts, alkylaryl sulfonate salts, dialkyl sulfosuccinate salts, polyoxyethylene alkylaryl ether phosphate ester salts, lignosulfonate salts and naphthalene sulfonate formaldehyde polycondensates; and nonionic surfactants such as polyoxyethylene alkyl aryl ethers, polyoxyethylene alkylpolyoxypropylene block copolymers and sorbitan fatty acid esters and cationic surfactants such as alkyltrimethylammonium salts.

Examples of the other formulation auxiliary agents include water-soluble polymers such as polyvinyl alcohol and polyvinylpyrrolidone, polysaccharides such as arabic gum, alginic acid and the salt thereof, CMC (carboxymethyl-cellulose), xanthan gum, inorganic materials such as aluminum magnesium silicate and alumina sol, preservatives, coloring agents and stabilization agents such as PAP (acid phosphate isopropyl) and BHT.

In an embodiment the composition may further comprise one or more antifreeze agent, wetting agents, fillers, surfactants, anticaking agents, pH-regulating agents, preservatives, biocides, antifoaming agents, colorants and other formulation aids.

Suitable antifreeze agents that can be added to the agrochemical composition are liquid polyols, for example ethylene glycol, propylene glycol or glycerol.

Wetting agents that can be added to the agrochemical composition of the present invention include, but are not limited to: polyarylalkoxylated phosphate esters and their potassium salts (e.g., Soprophor® FLK, Stepfac TSP PE-K. Other suitable wetting agents include sodium dioctylsulfosuccinates (e.g., Geropon® SDS, Aerosol® OT) and ethoxylated alcohols (e.g., Trideth-6; Rhodasurf® BC 610; Tersperse® 4894).

Optionally, about 0.1 wt % to about 5.0 wt % of antifoaming or defoamers are employed to stop any unwanted foam generated while manufacturing highly concentrated liquid biocide dispersion composition. The preferred antifoaming agent is selected from the group of silicone-based compounds, alcohols, glycol ethers, mineral spirits, acetylene diols, polysiloxanes, organosiloxanes, siloxane glycols, reaction products of silicon dioxide and organosiloxane polymer, polydimethylsiloxanes or polyalkylene glycols alone or in combination. Defoamers that are suitable include SAG-10; SAG-1000AP; SAG-1529; SAG-1538; SAG-1571; SAG-1572; SAG-1575; SAG-2001; SAG-220; SAG-290; SAG-30; SAG-30E; SAG-330; SAG-47; SAG-5440; SAG-7133 and SAG-770.

Examples of thickening agents based on anionic heteropolysaccharides from the xanthan gum group are inter alia the Rhodopol 23®, Rhodopol G®, Rhodopol 50 MD®, Rhodicare T®, Kelzan®, Kelzan S® and Satiaxane CX91®.

Preservatives used may be benzisothiazolinone (Proxel GXL) or phonols, 2-bromo-2-nitropropane-1,3-diol (Bioban BP 30), 5-chloro-2-methyl-4-isothiazolin-3-one & 2 methyl-4-isothiazolin-3 one (Kathon CG/ICP), Glutaraldehyde (Ucarcide 50), Chloromethyl isothiazolinone (CMIT)/Methylisothiazolinone (MIT) (Isocil Ultra 1.5), 2.2-dibromo-3-nitrilopropionamide (Reputain 20), Natamycin & Nisin, Bronopol/CMIT/MIT (Mergal 721K3).

Suitable colorants (for example in red, blue and green) are, preferably, pigments, which are sparingly soluble in water, and dyes, which are water-soluble. Examples are inorganic coloring agents (for example iron oxide, titanium oxide, and iron hexacyanoferrate) and organic coloring agents (for example alizarin, azo and phthalocyanin coloring agents).

Fillers may include an organic or inorganic solid inert substance such as talc, clay, diatomaceous earth, magnesium aluminum silicate, white carbon black, pyrophyllite, light calcium carbonate, high clay, organic bentonite, etc. or mixtures thereof.

The composition of the present invention maybe applied simultaneously as a tank mix or a formulation or may be applied sequentially. The application may be made to the soil before emergence of the plants, either pre-planting or post-planting. The application may be made as a foliar spray at different timings during crop development, with either one or two applications early or late post-emergence.

The compositions according to the invention can be applied before or after infection of the useful plants or the propagation material thereof by the fungi.

In an embodiment, the fungal diseases in soyabean cultivations include Asian Soyabean Rust (ASR) by Phakopsora pachyrhizi, powdery mildew by Erysiphe diffusa, Frogeye leaf spot (FLS) caused by the fungus, Cercospora sojina, brown spot caused by Septoria glycines, amongst several other diseases.

In an embodiment, the present method for controlling fungal phytopathogens comprises applying one or more multisite fungicides to a plant, plant part, locus or a propagation material in a soyabean cultivation.

In an embodiment, the present method for controlling fungal phytopathogens comprises applying at least two multisite fungicides to a plant, plant part, locus or a propagation material in a soyabean cultivation.

In an embodiment, the multi-site fungicides are selected from the group comprising a copper compound, sulphur, dithiocarbamates, phthalimides, chloronitriles, sulfamides, bis-guanidines, triazines, quinones, quinoxalines, maleimide and thiocarbamates.

In a preferred embodiment, the multisite fungicide is a copper compound.

In an embodiment, the copper compound is an inorganic copper compound.

In an embodiment, the copper compound is a copper salt.

In an embodiment, the copper compound is a copper salt selected from copper sulphate, tribasic copper sulphate, dibasic copper sulphate, copper oxychloride, copper chloride, copper oxide, cupric oxide, copper nitrate, copper perchlorate, copper bromide, copper hydroxide, copper iodide, cupric acetate and copper sulfate pentahydrate.

In a preferred embodiment, the copper compound is tribasic copper sulphate.

In an embodiment, the copper compound is copper sulphate.

In a preferred embodiment, the multisite fungicide is sulphur.

In an embodiment, the present method for controlling fungal phytopathogens comprises applying at least two multisite fungicides to a plant, plant part, locus or a propagation material in a soyabean cultivation, wherein the first multi-site fungicide is selected from a copper compound, and a second multi-site fungicide compound selected from sulphur.

In an embodiment, the present invention provides a method for controlling fungal phytopathogens comprising applying a combination of multisite fungicides comprising copper sulphate and sulphur to a plant, plant part, locus or propagation material in a soyabean cultivation.

In an embodiment, the present invention provides a method for controlling fungal phytopathogens comprising applying a combination of multisite fungicides comprising copper oxychloride and sulphur to a plant, plant part, locus or propagation material in a soyabean cultivation.

In a preferred embodiment, the present invention provides a method for controlling fungal phytopathogens comprising applying a combination of multisite fungicides comprising tribasic copper sulphate and sulphur to a plant, plant part, locus or propagation material in a soyabean cultivation.

In a preferred embodiment, the present invention provides a method for controlling fungal phytopathogens comprising applying a combination of multisite fungicides comprising copper or its salts and sulphur to a plant, plant part, locus or propagation material in a soyabean cultivation at an application rate ranging from 0.01 L/ha to 200 L/ha.

In a preferred embodiment, the present invention provides a method for controlling fungal phytopathogens comprising applying a combination of multisite fungicides comprising copper or its salts and sulphur to a plant, plant part, locus or propagation material in a soyabean cultivation at an application rate ranging from 0.05 L/ha to 20 L/ha.

In a preferred embodiment, the present invention provides a method for controlling fungal phytopathogens comprising applying a combination of multisite fungicides comprising a copper compound and sulphur to a plant, plant part, locus or propagation material in a soyabean cultivation at an application rate ranging from 0.1 L/ha to 10 L/ha.

In a preferred embodiment, the present invention provides a method for controlling fungal phytopathogens comprising applying a combination of multisite fungicides comprising tribasic copper sulphate and sulphur to a plant, plant part, locus or propagation material in a soyabean cultivation at an application rate ranging from 0.1 L/ha to 10 L/ha.

In a preferred embodiment, the present method for controlling fungal phytopathogens comprises applying one or more multisite fungicides comprising applying a combination of a tribasic copper sulphate and sulphur to a plant, plant part, locus or propagation material in a soyabean cultivation at an application rate ranging from 0.5 L/ha to 5 L/ha.

In a preferred embodiment, the present method for controlling fungal phytopathogens comprises applying one or more multisite fungicides comprising applying a combination of a tribasic copper sulphate and sulphur to a plant, plant part, locus or propagation material in a soyabean cultivation at an application rate ranging from 0.5 L/ha to 3 L/ha.

In an embodiment, the present invention provides a method for controlling fungal phytopathogens comprising applying a combination of multisite fungicides comprising copper or its salts and sulphur to a plant, plant part, locus or propagation material in a soyabean cultivation, wherein the application amount of copper or its salts is applied in an amount ranging from 100 to 5000 g ai/ha and sulphur is applied in an amount ranging from 10 to 500 g ai/ha.

In a preferred embodiment, the present invention provides a method for controlling fungal phytopathogens comprising applying a combination of multisite fungicides comprising copper or its salts and sulphur to a plant, plant part, locus or propagation material in a soyabean cultivation, wherein the application amount of copper or its salts is applied in an amount ranging from 500 to 2000 g ai/ha and sulphur is applied in an amount ranging from 50 to 300 g ai/ha.

In an embodiment, the present invention provides a method for controlling fungal phytopathogens comprising applying a combination of multisite fungicides comprising tribasic copper sulphate and sulphur to a plant, plant part, locus or propagation material in a soyabean cultivation, wherein tribasic copper sulphate is applied in an amount ranging from 100 to 5000 g ai/ha and sulphur is applied in an amount ranging from 10 to 500 g ai/ha.

In a preferred embodiment, the present invention provides a method for controlling fungal phytopathogens comprising applying a combination of multisite fungicides comprising tribasic copper sulphate and sulphur to a plant, plant part, locus or propagation material in a soyabean cultivation, wherein tribasic copper sulphate is applied in an amount ranging from 500 to 2000 g ai/ha and sulphur is applied in an amount ranging from 50 to 300 g ai/ha.

In a preferred embodiment, the present invention provides a method for controlling fungal phytopathogens comprising applying a combination of multisite fungicides comprising copper or its salts and sulphur to a plant, plant part, locus or propagation material in a soyabean cultivation, wherein the concentration of the copper or its salts is ranging from 1 g/kg to 200 g/kg and the concentration of the sulphur is ranging from 100 to 800 g/kg.

In a preferred embodiment, the present invention provides a method for controlling fungal phytopathogens comprising applying a combination of multisite fungicides comprising tribasic copper sulphate and sulphur to a plant, plant part, locus or propagation material in a soyabean cultivation, wherein the concentration of the copper or its salts is ranging from 1 g/L to 200 g/L and the concentration of the sulphur is ranging from 100 g/L to 1000 g/L.

In a preferred embodiment, the present invention provides a method for controlling fungal phytopathogens comprising applying a combination of multisite fungicides comprising tribasic copper sulphate and sulphur to a plant, plant part, locus or propagation material in a soyabean cultivation, wherein the concentration of the copper or its salts is ranging from 10 g/kg to 100 g/kg and the concentration of the sulphur is ranging from 100 to 800 g/kg.

In a preferred embodiment, the present invention provides a method for controlling fungal phytopathogens comprising applying a combination of multisite fungicides comprising tribasic copper sulphate and sulphur to a plant, plant part, locus or propagation material in a soyabean cultivation, wherein the concentration of the copper or its salts is ranging from 20 g/kg to 80 g/kg and the concentration of the sulphur is ranging from 200 to 800 g/kg.

In a preferred embodiment, the present invention provides a method for controlling fungal phytopathogens comprising applying a combination of multisite fungicides comprising tribasic copper sulphate and sulphur to a plant, plant part, locus or propagation material in a soyabean cultivation, wherein the concentration of the copper or its salts is ranging from 40 g/kg to 60 g/kg and the concentration of the sulphur is ranging from 400 to 700 g/kg.

In a preferred embodiment, the present invention provides a method for controlling fungal phytopathogens comprising applying a combination of multisite fungicides comprising tribasic copper sulphate and sulphur to a plant, plant part, locus or propagation material in a soyabean cultivation, wherein the concentration of the copper or its salts is 80 g/kg and the concentration of the sulphur is 640 g/kg.

In an embodiment, the method of controlling phytopathogenic fungal diseases of the present invention is applied to fungal diseases in soyabean cultivations including Asian Soyabean Rust (ASR) by Phakopsora pachyrhizi, powdery mildew by Erysiphe diffusa, Frogeye leaf spot (FLS) caused by the fungus, Cercospora sojina, brown spot caused by Septoria glycines, purple seed stain caused by Cercospora kikuchii, sphaceloma scad caused by Elsinoe glycines, pod and stem blight caused by Diaporthe phaseolorum var. sojae, amongst several other diseases.

In an embodiment, the method of present invention provides effective controlling of fungal pathogens such that, the method can be applied at pre or post emergence of the fungal diseases, thereby providing resistance management and complete control of the fungal pathogens.

In an embodiment, the method of present invention provides a method for effective controlling of fungal pathogens such that, the method can be applied at the pre-harvest stage or post-harvest stage of crops.

In an embodiment, the composition of the present invention can be combined with at least one additional agrochemical component/pesticide. Examples of such pesticides include but are not limited to herbicides, fungicides, miticides, larvicides, avicides, insecticides, nematicides and rodenticides.

In another embodiment, the method of the present invention further comprises applying a fungicidal compound or, an insecticide compound or an herbicidal compound either concurrently or subsequently or sequentially to the locus of crops.

In an embodiment, the present method for controlling the growth of fungal pathogens is extended for use as an eco-friendly wide spectrum product against pests.

According to an embodiment of the present disclosure, a kit is provided, said kit comprises a plurality of components, each of which includes at least one of the ingredients of the disclosed fungicide combinations.

In one embodiment of the present disclosure, the kits may include at least one of the components used to prepare the fungicide composition or may include the components.

For example, the kits may include at least two multi-site fungicides, and at least two systemic fungicides. One or more of the components may be combined together or pre-formulated within the kit. In those embodiments where more than two components are provided in a kit, the components may already be combined together and as such are packaged in a single container such as a vial, bottle, can, pouch, bag or canister.

In other embodiments, two or more components of a kit may be packaged separately, i.e., not pre-formulated. As such, the kits may include one or more separate containers such as vials, cans, bottles, pouches, bags and/or canisters, each container containing a separate component for the stable herbicidal composition.

In both forms, a single component of the kit may be applied separately from or together with the other components, or as a component of a combined composition for preparing the insecticidal combinations disclosed herein.

In view of the above, it will be seen that the several advantages of the disclosure are achieved, and other advantageous results are attained. Although the present disclosure has been disclosed in full, it will be understood that numerous additional modifications and variations could be made thereto without departing from the scope of the disclosure. The embodiments may be combined together for better understanding of the disclosure, without departing from the scope of the disclosure.

In another embodiment, alternative or multiple embodiments of the disclosure disclosed herein are not to be construed as limitations. Each embodiment can be referred to and claimed individually or in any combination with other embodiments of the disclosure. One or more embodiments of the disclosure can be combined together to exhibit the teaching of the invention, without departing from the scope of the disclosure.

The invention shall now be described with reference to the following specific examples. It should be noted that the examples appended below illustrate rather than limit the invention and that those skilled in the art will be able to design many alternative embodiments without departing from the scope of the present invention.

It will be understood that the specification and examples are illustrative but not limiting of the present disclosure and that other embodiments within the spirit and scope of the disclosure will suggest themselves to those skilled in the art. Other embodiments can be practiced that are also within the scope of the present disclosure. The following examples illustrate the disclosure, but by no means intend to limit the scope of the claims.

### EXAMPLES

### Example 1

The combination of sulphur and tribasic copper sulphate was evaluated for its fungicidal activity in soyabean cultivations. Treatment 1 was the soyabean crop not treated with the combination of the present invention, treatments 2 to 4 include applications of sulfur and tribasic copper sulphate. A total of six sprays was made, each with an interval of 10 days, each spray was designated as A, B, C, D, E, and F. The observations for efficacy in the control of the fungal phytopathogens were made at seven days after the last application—F (i.e 7 DAF). The % control of Phakopsora pachyrhizi and Erysiphe diffusa was determined.

TABLE 1
Treatment protocol

| | Treat- | Conc. | | | | |
|---|---|---|---|---|---|---|
| Treat- | ment/ | (g | | | | |
| ment | Active | a.i./ | | | | |
| No. | ingredient | L-kg) | Form. | Rate | Unit | Timing |
| 1 | Untreated | — | — | — | — | — |
| | Control | | | | | |
| 2 | Sulfur + | 640 | SC | 2 | L/ha | ABCDEF |
| | Tribasic | + | | | | |
| | Copper | 80 | | | | |
| | Sulphate | | | | | |
| 3 | Sulfur + | 640 | SC | 3 | L/ha | ABCDEF |
| | Tribasic | + | | | | |
| | Copper | 80 | | | | |
| | Sulphate | | | | | |
| 4 | Sulfur + | 640 | SC | 4 | L/ha | ABCDEF |
| | Tribasic | + | | | | |
| | Copper | 80 | | | | |
| | Sulphate | | | | | |

SC: Suspension concentrate

TABLE 2
Evaluation of % control of Phakospora pachyrhizi

| | Treatment/Active | Conc. | |
|---|---|---|---|
| Treat. | ingredient | (g a.i./L-kg) | % control |
| 1 | Untreated Control | — | 0 |
| 2 | Sulfur + Tribasic | 640 + 80 | 94.5 |
| | Copper Sulphate | | |
| 3 | Sulfur + Tribasic | 640 + 80 | 96.2 |
| | Copper Sulphate | | |
| 4 | Sulfur + Tribasic | 640 + 80 | 96.5 |
| | Copper Sulphate | | |

TABLE 3
Evaluation of % control of Erysiphe diffusa

| | Active | Conc. | |
|---|---|---|---|
| Treat. | ingredient | (g a.i./L-kg) | % control |
| 1 | Untreated Control | — | 0 |
| 2 | Sulfur + Tribasic | 640 + 80 | 98.7 |
| | Copper Sulphate | | |
| 3 | Sulfur + Tribasic | 640 + 80 | 99.7 |
| | Copper Sulphate | | |
| 4 | Sulfur + Tribasic | 640 + 80 | 96.2 |
| | Copper Sulphate | | |

The % control of the fungal phytopathogens of Erysiphe diffusa and Phakopsora pachyrhizi in soyabean crop was found to be significantly high, therefore the said combination of the sulphur and tribasic copper sulphate is effective in controlling fungal diseases in soybean cultivations.

1. A method for controlling fungal diseases in soyabean crop comprising applying to a plant, plant part, locus or a propagation material a fungicidal combination/composition comprising one or more multisite fungicides, wherein the multi-site fungicide comprises one or more inorganic fungicides selected from copper or its salts and sulphur.

2. (canceled)

3. (canceled)

4. The method as claimed in claim 1, wherein the copper salt selected from copper sulphate, tribasic copper sulphate, dibasic copper sulphate, copper oxychloride, copper chloride, copper oxide, cupric oxide, copper nitrate, copper perchlorate, copper bromide, copper hydroxide, copper iodide, cupric acetate, and copper sulfate pentahydrate.

5. The method as claimed in claim 1, wherein the fungicidal combination comprises tribasic copper sulphate and sulphur.

6. The method as claimed in claim 1, wherein the ratio of the copper salt to sulphur is ranging from 1:1 to 1:15.

7. The method as claimed in claim 1, wherein the combination further comprises a systemic fungicide.

8. The method as claimed in claim 1, wherein the fungal diseases in soyabean crop comprise Asian Soyabean Rust (ASR) by Phakopsora pachyrhizi, powdery mildew by Erysiphe diffusa, Frogeye leaf spot (FLS) by Cercospora sojina, brown spot caused by Septoria glycines, purple seed stain by Cercospora kikuchii, sphaceloma scad by Elsinoe glycines, or pod and stem blight by Diaporthe phaseolorum var. sojae.

9. The method as claimed in claim 1, wherein copper or its salts is applied in an amount ranging from 500 to 2000 g ai/ha and sulphur is applied in an amount ranging from 50 to 300 g ai/ha.

10. The method as claimed in claim 1, wherein the application rate is ranging from 0.05 L/ha to 20 L/ha.

11. A fungicidal combination comprising one or more multisite fungicides for controlling fungal diseases in soyabean crop, said combination comprising one or more inorganic fungicides selected from copper or its salts and sulphur.

12. The combination as claimed in claim 11, the fungicidal combination comprising tribasic copper sulphate and sulphur.

13. The combination as claimed in claim 11, wherein the ratio of the copper salt to sulphur is ranging from 1:1 to 1:15.

14. A fungicidal composition for controlling fungal diseases in soyabean crop, the composition comprising one or more multi-site fungicides and one or more agrochemically acceptable excipients, wherein the multi-site fungicide comprises one or more inorganic fungicides selected from copper or its salts and sulphur.

15. The composition as claimed in claim 14, wherein the concentration of the copper or its salts is ranging from 10 g/kg to 100 g/kg and the concentration of sulphur is ranging from 200 to 700 g/kg.
